(19) United States
(12) Patent Application Publication
(10) Pub. No.: US 2019/0278028 A1
(43) Pub. Date: Sep. 12, 2019

(54) Sequential Extraction of Fiber Optic Connectors in a High Density Connector Environment

(71) Applicant: US Conec, Ltd, Hickory, NC (US)

(72) Inventor: Jason Higley, Hickory, NC (US)

(21) Appl. No.: 16/294,523

(22) Filed: Mar. 6, 2019

Related U.S. Application Data
(60) Provisional application No. 62/639,019, filed on Mar. 6, 2018.

(51) Int. Cl. G02B 6/38

(52) U.S. Cl. CPC G02B 6/3817; G02B 6/3897; G02B 6/3825

(57) ABSTRACT

An apparatus acts as a carrier and also as a removal system to remove as some fiber optic connectors in a non-simultaneous manner. The apparatus has surfaces that engage less than all of the fiber optic connectors simultaneously, reducing the amount of pulling force required to remove the fiber optic connectors.

### REFERENCE TO RELATED CASE

This application claims priority under 35 U.S.C. § 119 (e) to provisional application No. 62/639,019 filed on Mar. 6, 2018, contents of which are hereby incorporated by reference in their entirety.

### BACKGROUND OF THE INVENTION

### Field of the Invention

There is an increasing demand for a higher number of fiber optic connectors in a smaller space. This demand is driven by high speed data centers and on-board optics applications. Usually fiber optic connectors are mounted in a panel and are tightly packed together. Such a panel and a number of fiber optic connectors inserted therein are illustrated in FIG. 1. Fiber optic connectors have to be removed and attached/inserted as needed for various reasons (changing polarity, monitoring signal strength, etc.). Often the removal of the fiber optic connectors involved removing or installing a ganged set or group of connectors that are removed simultaneously and then may be reinserted back into an adapter in the panel together. It is desirable to remove the group of connectors using minimal force—both for the user as well as for the fiber optic connectors and adapter or panel parts.

There are other arrangements that allow for the insertion and removal of ganged sets of fiber optic connectors. For example, U.S. Pat. No. 9,857,538, incorporated by reference in its entirety herein and owned by the current Applicant, discloses the use of side latches on a plug attached to an adapter that a user can use to comfortably attach or remove a ganged set of connectors. See FIG. 2. Other arrangements and techniques may require the user to pull on other features on the carrier, the adapter, and/or the fiber optic connectors to remove a ganged set of fiber optic connectors. This may be difficult in the higher density installations as there may be insufficient space for a user's fingers or a tool to grip onto any portion of the carreir, adapter or fiber optic connectors. Additionally, the removal of the ganged set of fiber optic connectors requires a lot of force. Further, this force increases linearly as the number of fiber optic connectors in a ganged set increases. A user doing this for hundreds of connectors (as is typical in a high density environment) may get fatigued, unless there are features on the adapter/carrier/connector that help the user reduce the force needed to remove the fiber optic connectors. Likewise, too much force applied to a connector or a group of fiber optic connectors, or even a carrier or an adapter, could potentially damage these parts. Furthermore, if a fiber optic connector resists insertion or removal, it may cause the user to twist or pivot the ganged set causing damage to the fiber optic connectors being inserted or those fiber optic connectors that are positioned close to the fiber optic connectors being inserted or removed.

In order to prevent such issues and to better ensure easier removal, a new apparatus and method to remove a ganged set of fiber optic connectors has been designed.

### SUMMARY OF THE INVENTION

The present invention is directed to an apparatus for removing a plurality of fiber optic connectors that includes a main body to engage to at least a portion of each of the plurality of fiber optic connectors, an extension extending rearwardly from the main body, the extension configured to be grasped by a user to remove the plurality of fiber optic connectors, at least one first surface to engage one of the plurality of fiber optic connectors, and at least one second surface to engage another of the plurality of fiber optic connectors, the at least one first surface being located distally from the at least one second surface.

In some embodiments, the at least one first surface and the at least one second surface assist to define a respective opening in a top portion of the main body.

In some other embodiments, the at least one first surface and the at least one second surface are disposed within a main opening in the main body.

According to another aspect of the present invention, there is an apparatus for removing a plurality of fiber optic connectors that includes a main body to engage to at least a portion of each of the plurality of fiber optic connectors, an extension extending rearwardly from the main body, the extension configured to be grasped by a user to remove the plurality of fiber optic connectors; and means for engaging a portion of each of the plurality of fiber optic connectors wherein at least two of the fiber optic connectors are not unattached from a structure simultaneously.

According to yet another aspect of the present invention, there is an apparatus for removing a plurality of fiber optic connectors that includes a plurality of fingers extending upward from a base at front end thereof, each of the fingers having at least one surface facing toward a Rear end of the base to engage a portion of a fiber optic connector; and an opening between each of the plurality of fingers to receive the portion of the fiber optic connector, wherein at least two of the surfaces are parallel to one another but offset from each other.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is an elevational view of tightly spaced fiber optic connectors in a high density application;

FIG. 2 is a perspective view of a ganged set of fiber optic connectors with side latches;

FIG. 3 is a top view of one embodiment of an apparatus for removing a plurality of fiber optic connectors according to the present invention and having a plurality of fiber optic connectors engaged thereto;

FIG. 4 is a perspective view of the apparatus for removing a plurality of fiber optic connectors of FIG. 3 without the fiber optic connectors;

FIG. 5 is one embodiment of a fiber optic connector that could be used with the apparatus in FIGS. 3 and 4;

FIG. 6 is a cross section of a portion of the fiber optic connector of FIG. 5 showing the relevant portions for use with the apparatus in FIGS. 3 and 4;

FIG. 7 is a cross section view of a portion of the fiber optic connector of FIG. 5 and a portion of the apparatus of FIG. 3;

FIG. 8 is an elevational view of a cross section of the fiber optic connector and apparatus along the line 8-8 in FIG. 7;

FIG. 9 is an elevational view of the cross section of the fiber optic connector and apparatus in FIG. 7;

FIG. 10 is an elevational view of the cross section of the fiber optic connector and apparatus in FIG. 8 with the apparatus being moved to the right;

FIG. 11 is a perspective view from the rear of a plurality of fiber optic connectors and apparatuses to be inserted into adapters in a high density application like in FIG. 1;

FIG. 12 is a perspective view of another embodiment of an apparatus for removing a plurality of fiber optic connectors according to the present invention;

FIG. 13 is a perspective view of another embodiment of an apparatus for removing a plurality of fiber optic connectors according to the present invention and having a plurality of fiber optic connectors engaged thereto; and

FIG. 14 is an enlarged view of a portion of the apparatus in FIG. 13.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

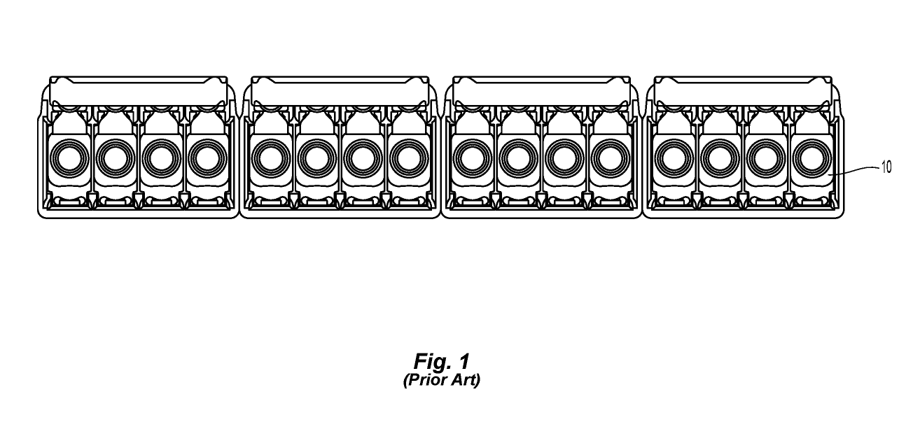

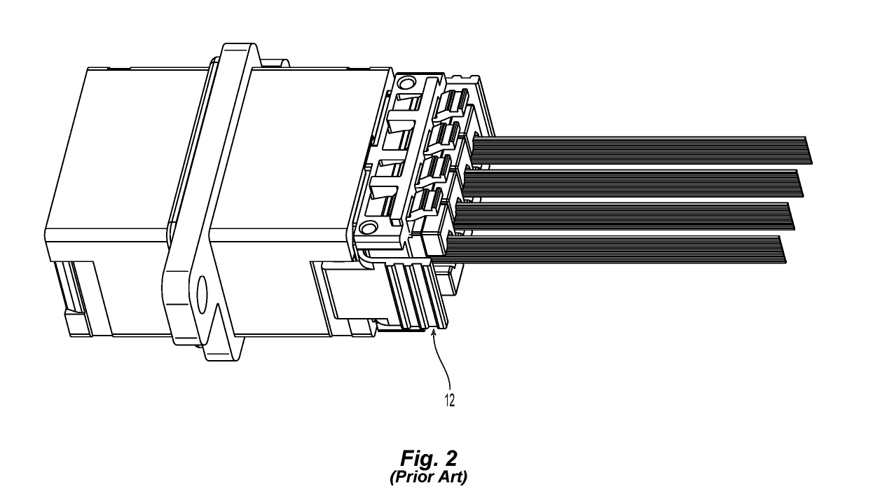

As noted above, FIG. 1 illustrates fiber optic connectors 10 that are very tightly spaced in the prior art. There is little room between the ganged set of fiber optic connectors 10. Indeed, there is practically no room for a latching mechanism such as the side latching mechanism 12 in FIG. 2. The latching mechanism 12 is an example from U.S. Pat. No. 9,857,538, incorporated by reference in its entirety herein and owned by the current Applicant. Given the small amount of real estate available for devices to remove fiber optic connectors, Applicant has found that the new apparatus described herein allow for the removal of the fiber optic connectors in a high density environment and reduce the force necessary to remove ganged fiber optic connectors.

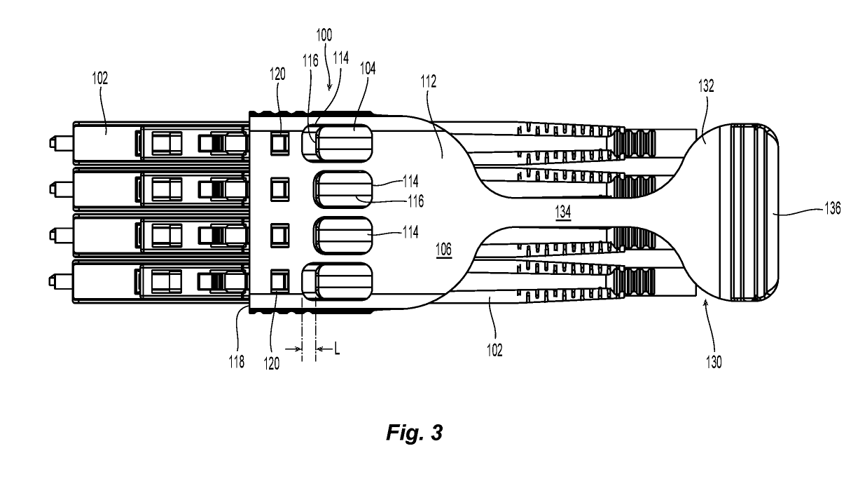

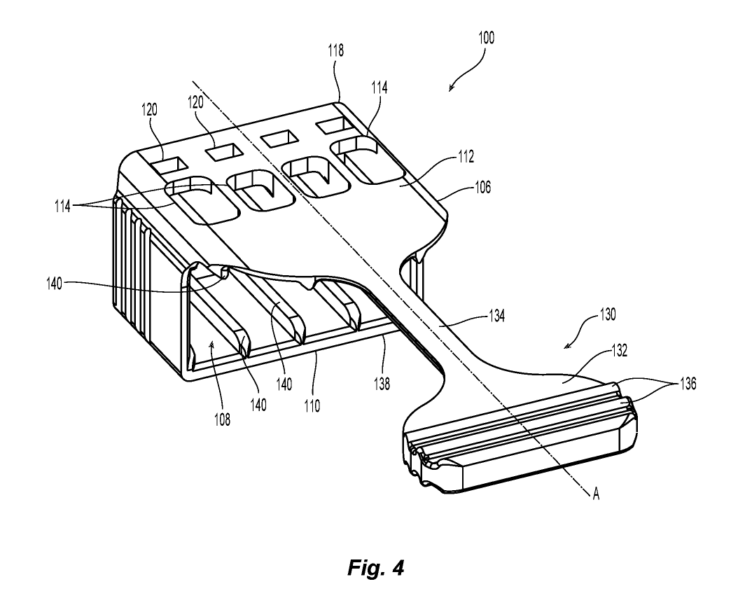

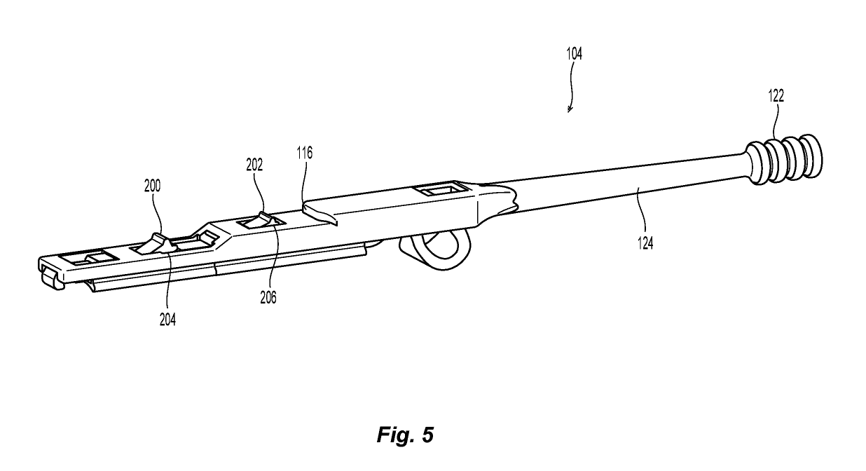

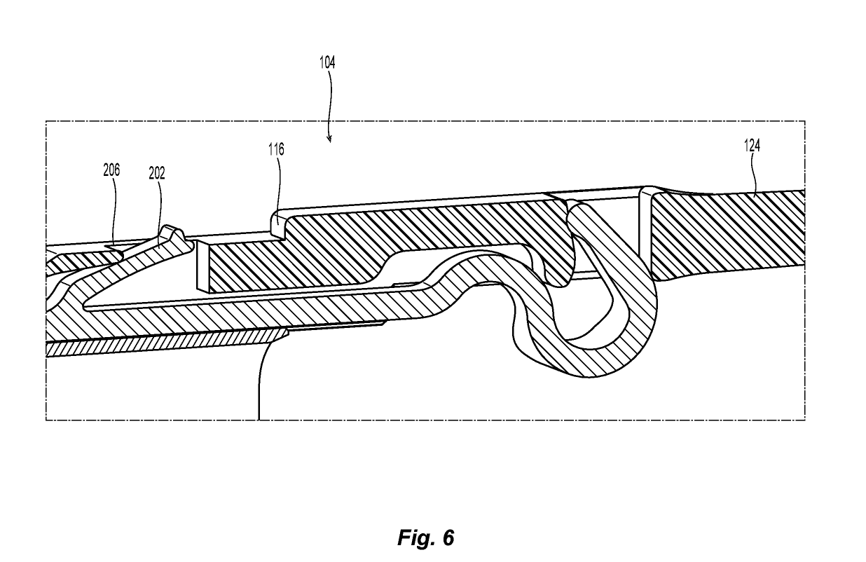

Turning to FIGS. 3 and 4, one embodiment of an apparatus 100 for removing a plurality of fiber optic connectors 102 according to the present invention is illustrated. The apparatus 100 can be used with a plurality of fiber optic connectors 102 such as those illustrated in FIGS. 3 and 5-6. FIGS. 5 and 6 illustrate a push-pull tab 104 on the fiber optic connector 102 that interacts with the apparatus 100 as described below. The fiber optic connector 102 and push-pull tab 104 are discussed in great detail in PCT application PCT/US18/66523, the contents of which are incorporated herein by reference.

The apparatus 100 has a main body 106 to engage to at least a portion of each of the plurality of fiber optic connectors 102. In this embodiment, each of the fiber optic connectors 102 are inserted into the main body 106 of the apparatus 100. While there are four of the fiber optic connectors 102 inserted into the apparatus 100, the apparatus 100 may be configured to receive more (e.g., 6, 8, etc.) or fewer (e.g., 2). The apparatus 100 has a main body 106 that preferably surrounds the fiber optic connectors 102. In this manner, the apparatus 100 is also a carrier and keeps the four fiber optic connectors 102 ganged together. The main body 106 has a main opening 108 that receives the four fiber optic connectors 102. The fiber optic connectors 102 are preferably inserted into the apparatus 100 from a rear end 110 of the main body 108.

In this application, Applicant uses that the term “front” or “forward” means that direction where the fiber optic connector would meet with another fiber-optic connector or device, while the term “rear” or “rearward” is used to mean the direction from which the optical fibers enter into the fiber-optic ferrule or fiber optic connector. Thus, “front” with respect to the apparatus illustrated in FIG. 3 is on the left side of the figure. The rear or rearward direction would be the opposite direction—or to the right in FIG. 3. The view in FIG. 4 is from the rear end 110 of the apparatus 100.

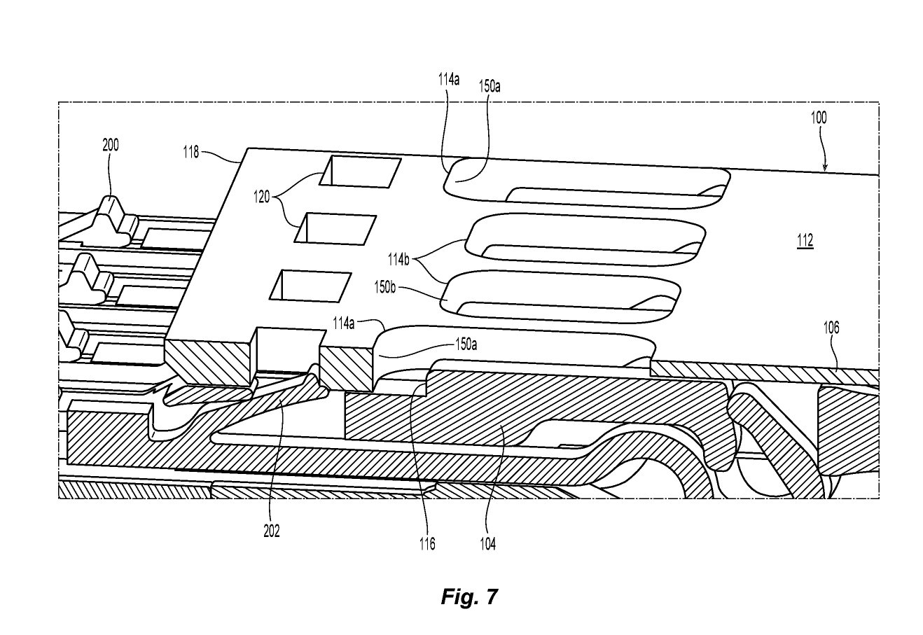

The main body 106 has a top portion 112, which has four top openings 114 to receive a portion of the push-pull stop 116 of the push-pull tab 104. Forward of the four top openings 114 are four more carrier notches or openings 120 to receive a portion of the push-pull tab 104 that are used to insert the fiber optic connectors 102 into an adapter. See e.g. FIG. 7.

The apparatus 100 also has an extension or handle 130 that extends rearwardly from the main body 106. The extension 130 is shaped like the tail of a whale, but may take any form. The tail shape allows for a sufficiently sized surface 132 at the rear of the extension 130 for a user to easily grasp the apparatus 100 and have good leverage. The narrow portion 134 between the main body 106 and surface 132 allows for the user to be able to see the plurality of fiber optic connectors 102 in the main opening 108 of the apparatus 100. Thus, the apparatus 100 and the extension 130 do not block the view of someone who is checking on the orientation and/or the installation status of the fiber optic connectors 102. The surface 132 may have ridges or corrugations 136 to further assist the user in having sufficient grip on the assembly 100. While the extension 130 is illustrated to be attached to the top portion 112, it could also be attached to other areas on the main body 106, including for example a bottom portion 138.

In the main opening 108 of the main body 106, the assembly 100 has a number of elongated projections 140. The elongated projections 140 extend from an inside surface 142 of the main body 106 into the main opening 108 and provide for horizontal alignment of the fiber optic connectors 102 within the assembly 100. See FIG. 4. The elongated projections 140 run parallel to a longitudinal axis A through the apparatus 100, and are preferably on both the bottom portion 138 and the top portion 112.

To remove the fiber optic connectors 102 in a sequential or non-simultaneous manner, it is preferable that at least two of the fiber optic connectors 102 in apparatus 100 are removed at different times. The apparatus 100 has surfaces to engage the fiber optic connectors at different times during the removal of the apparatus 100 (with the fiber optic connectors 102 disposed therein). To have the surfaces engage the fiber optic connectors 102 at different times during removal, the surfaces have to be located at different positions along the axis (longitudinal axis A in this case) of removal of the apparatus 100. Thus, as the apparatus 100 is removed (pulled rearwardly), the surfaces that engage the fiber optic connectors will engage the fiber optic connectors sequentially so they are not all removed at the same time. The top openings 114 in this case provide the surfaces that engage the fiber optic connectors 102.

A brief discussion of the fiber optic connector 102 and the push-pull tab 104 is appropriate here even though the description of the fiber optic connector and push-pull tab have been incorporated by reference. FIGS. 5 and 6 illustrate the important portions of the push-pull tab 104. The push-pull tab 104 has two latches, an adapter latch 200 and a carrier latch 202. The adapter latch 200 extends through front window 204 and the carrier latch 202 extends through the rear window 206. The adapter latch 200 engages the adapter (or other structure or piece of equipment) to attach the fiber optic connector to the adapter. The carrier latch 202 engages the carrier notches or openings 120 in the apparatus 100. See, e.g., FIG. 7. When the push-pull tab 104 is pulled rearwardly, the push-pull tab body 208 is pulled rearwardly relative to a latch body 210. As a result, the push-pull tab body 208 pushes the adapter latch 200 and the carrier latch 202 into their respective windows, releasing the fiber optic connector 102 from the adapter and/or the carrier and allowing the fiber optic connector 102 to be removed. However, when the push-pull tab 104 is pushed in a forward direction—to install the fiber optic connectors 102 - then the carrier latch 202 engages the carrier notches 120 allowing the fiber optic connector to be inserted into the adapter.

The push-pull stop 116 is a forward facing surface of the push-pull tab 104 behind the adapter latch 200 and the carrier latch 202. See FIGS. 5-7. The push-pull stop 116 extends upward and into the top openings 114. As best seen in FIG. 7, the top portion 112 is thinner between the top openings 114 and the rear end 110 to accommodate the push-pull stop 116. This configuration allows the apparatus 100 to engage the push-pull stop 116.

Turning to FIGS. 3-4 and 7-10, the top openings 114 have a rearward facing surface 150. It so happens that the rearward facing surfaces 150 also help to form the top openings 114. As can be seen in FIG. 4, the two outside top openings 114a are the same and the two inside top openings 114b are the same. The size of all four of the top openings 114 may be the same size as well. The two outside top openings 114a have the surfaces 150a and the two inside top openings 114b have the surfaces 150b. FIG. 3 illustrates that surfaces 150a are disposed farther forward toward the front (distally) 118 of the main body 106 than the surfaces 150b by a distance L. Thus, when the apparatus 100 is pulled rearwardly when the fiber optic connectors 102 are removed from an adapter (not shown), the apparatus 100, and the surfaces 150b in particular, will engage the push-pull stop 116 of the two fiber optic connectors 102 on the inside first. As the apparatus 100 continues to move in the rearward direction, the surfaces 150a will then engage the push-pull stop 116 of the two fiber optic connectors 102 on the outside. Thus, the two inside fiber optic connectors 102 are disengaged from the adapter (or other structure or piece of equipment) before the two outside fiber optic connectors 102 are similarly disengaged. It should be noted that the openings 114 could be reversed such that the outside fiber optic connectors 102 are disengaged before the inside fiber optic connectors 102. The top openings 114 could also be arranged such that the two surfaces 150a and the two surfaces 150b are not adjacent to one another, e.g., the first and third or the second and fourth fiber optic connectors could be removed first.

Thus, when there are two fiber optic connectors in an apparatus that has only room for two, one of the fiber optic connectors would be removed before the other. When there are more fiber optic connectors (e.g., six or eight), then there are a number of ways to remove the fiber optic connectors such that all of them are not removed simultaneously. For example, with six connectors, two fiber optic connectors could be removed with three different sets of surfaces or three could be removed with two different sets of surfaces.

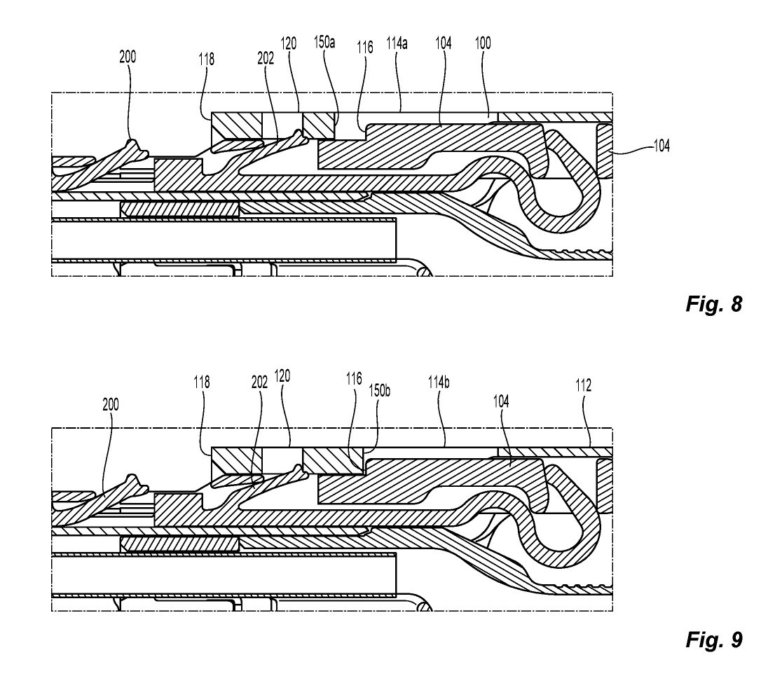

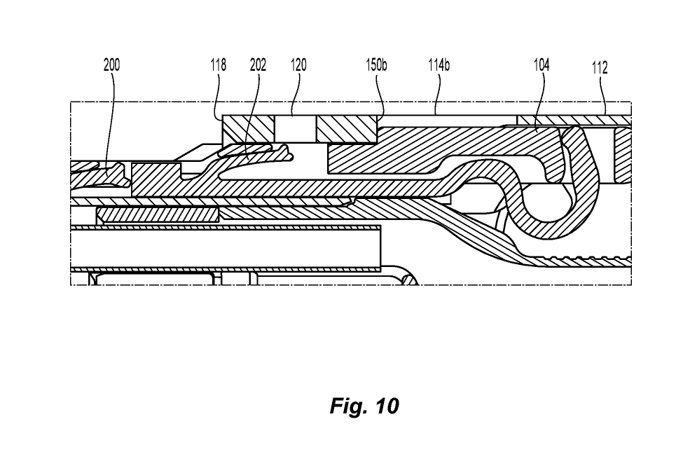

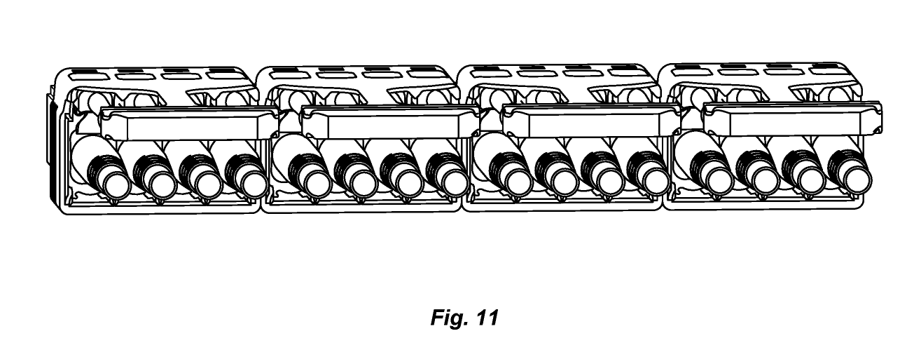

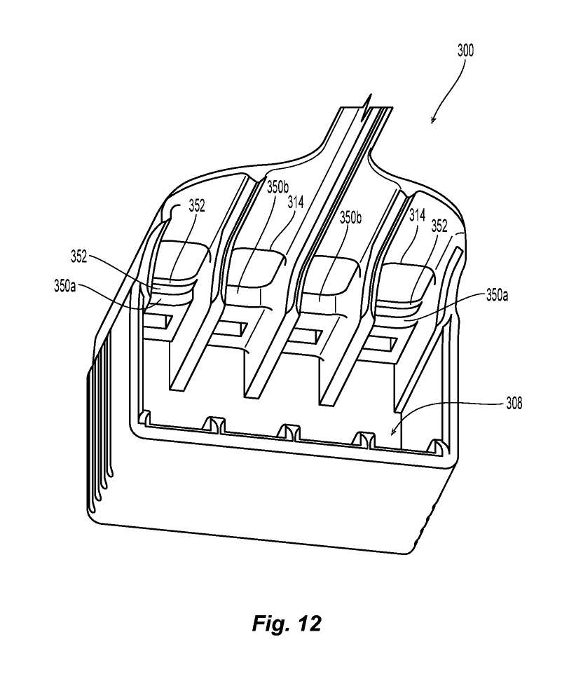

FIG. 8 illustrates a cross sectional view through a portion of the apparatus 100 and the push-pull tab 104 through the outside top opening 114. The apparatus 100 or the push-pull tab 104 could be used to insert the fiber optic connector into an adapter. FIG. 9 illustrates a cross sectional view through a portion of the apparatus 100 and the push-pull tab 104 through the inside top opening 114. See also FIG. 3 where the apparatus 100 and the push-pull tab 104 are at the same positions relative to one another. FIG. 10 shows the same cross sectional view as in FIG. 9, but the apparatus 100 has been pulled rearwardly with respect to the push-pull tab 104 (the adapter is not shown for clarity), causing the adapter latch 200 to be pushed down, releasing the fiber optic connector. The apparatus 100 has engaged the push-pull stop 116 of the push-pull tab 104 of the inside fiber optic connector and continuing the pull on the apparatus 100 will remove the fiber optic connector from the adapter. The outside fiber optic connectors would have already been removed from the adapter in FIG. 10. A view of a plurality of ganged fiber optic connectors using the apparatus 100 is illustrated in FIG. 11.

Another embodiment of an apparatus 300 is illustrated in FIG. 12. In this embodiment, the apparatus 300 has the rearward facing surfaces 350 that engage the push-pull stop 116 of the push-pull tab 104 inside the main opening 308. The top openings 314 can be the same size since the rearward facing surfaces 350 do not form a part of the top openings, in at least some of the openings. For example, the two outside surfaces 350a are forward of the top openings 314a and extend downward into the main opening 308 to engage the push-pull stop 116. The inside surfaces 350b are illustrated as being aligned with the top openings 314b, but they could be moved so that they do not coincide with the top openings 314b. As noted above, the goal is to have some of the fiber optic connectors removed at different times as the assembly 300 is moved rearwardly. Thus, the openings 314 could be smaller and allow the area 352 between the top openings 314 and the rearward facing surfaces 350 to be larger. Again, the order of the fiber optic connectors being removed can be changed from the inside first to those on the outside being first. Similarly, the positions could be moved so that the optic fiber connectors that are removed at the same time are not next to one another.

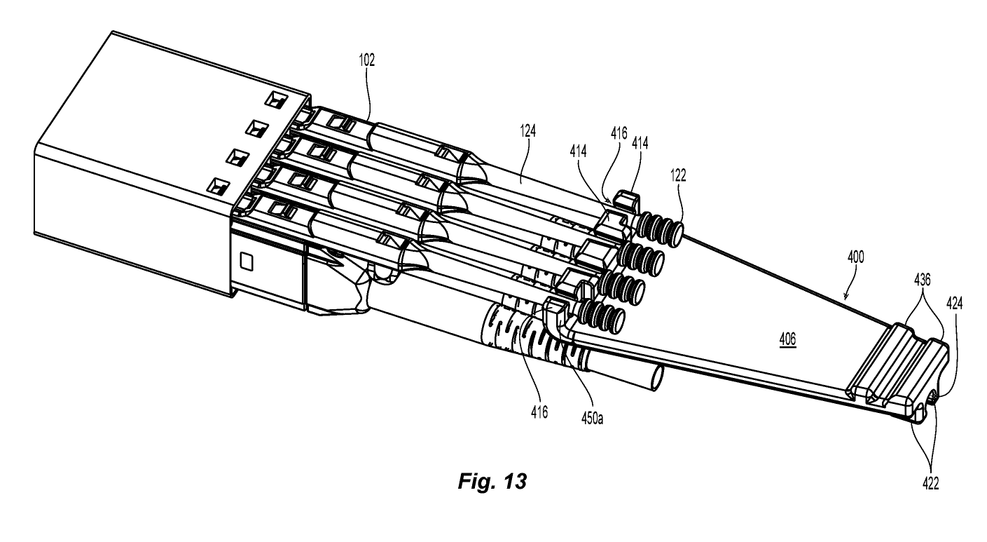

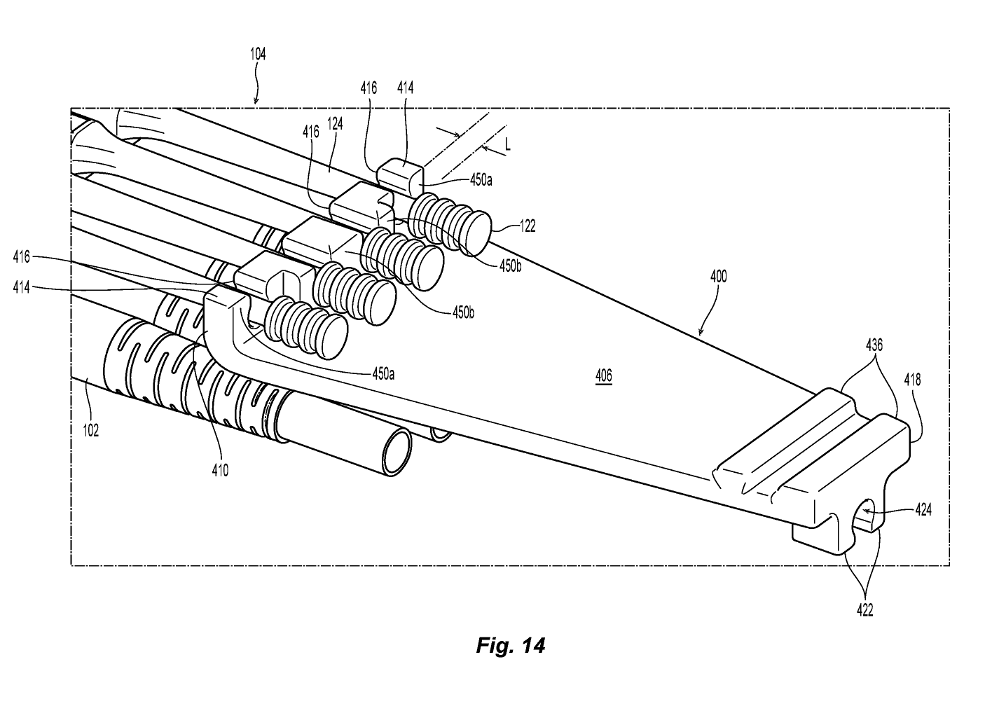

Another embodiment of an apparatus 400 is illustrated in FIGS. 13-14. In this embodiment, the apparatus has a main body or base 406 that extends between a front end 418 and a rear end 410. At or near the rear end 410 are a plurality of fingers 414 that extend upward from the base 406. It should be noted that the apparatus could be turned over so the fingers extend in the opposite direction, thereby changing up and down. However, the apparatus 400 operates in either orientation. Additionally, while the fingers 414 are illustrated at the very end of the apparatus 400, they could be moved toward the front end 418 and still fall within the scope of the present invention. Obviously, the farther forward the fingers 414 are disposed along the main body 406 toward the front end 418, the less area between a grasping portion 420 of the apparatus 400 and the grasping portion 122 of the push-pull tab 104 is available to the user, potentially limiting the leverage.

Between the interior fingers 414 are openings 416 that receive a handle portion 124 of the push-pull tab 104 attached to a fiber optic connector 102. A grasping portion 122 of the handle portion 124 engages rearward facing surfaces 450 of the fingers 414 of the apparatus 400. FIG. 14 illustrates that the surfaces 450b will engage the grasping portion 122 of the handle portion 124 before the surfaces 450a. Thus, as a user pulls on apparatus 400, the surfaces 450b engage the two inside fiber optic connectors. Then as the user continues to pull on the apparatus 400, the surfaces 450a engage the grasping portion 122 of the handle portion 124 of the outside fiber optic connectors, removing those after the inside fiber optic connectors have been removed. While the longitudinal difference in the distance between the two surfaces 450a and 450b is L, that distance could be modified to make sure that some of the fiber optic connectors are removed first before a second set of fiber optic connectors are removed to reduced the overall pulling force on the apparatus 400.

As is clear from FIG. 14, two of the fingers 414a have two different rearward facing surfaces 450 when the fingers 414 are disposed between two fiber optic connectors that are going be pulled out at different times (e.g., the second and fourth fingers). It is also possible to two different fingers with two different rearward facing surfaces in place of the single finger 414a. The fingers can also be changed to allow for the outside fiber optic connectors to be removed first and then the inside fiber optic connectors.

The apparatus 400 also has two features at the front end 418. First, there are ridges or corrugations 436 to further assist the user in having sufficient grip on the assembly 400. There may be ridges or corrugations on both sides (top and bottom) of the apparatus, or just on one side. Second, the front end 418 also has one side, two smaller fingers 422 with an opening 424 therebetween. The apparatus 400 can be turned around and a single fiber optic connector can be removed by putting the handle portion 124 in the opening 424 and pulling on the apparatus 400.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. An apparatus for removing a plurality of fiber optic connectors comprising:
a main body to engage to at least a portion of each of the plurality of fiber optic connectors;
an extension extending rearwardly from the main body, the extension configured to be grasped by a user to remove the plurality of fiber optic connectors;
at least one first surface to engage one of the plurality of fiber optic connectors; and
at least one second surface to engage another of the plurality of fiber optic connectors, the at least one first surface being located distally from the at least one second surface.

2. The apparatus according to claim 1, wherein the at least one first surface and the at least one second surface assist to define a respective opening in a top portion of the main body.

3. The apparatus according to claim 1, wherein the at least one first surface and the at least one second surface are disposed within a main opening in the main body.

4. The apparatus according to claim 1, wherein the at least one first surface and the at least one second surface engage a push-pull tab on the fiber optic connector.

5. The apparatus according to claim 1, wherein the at least one first surface includes two first surfaces and the at least one second surface includes two second surfaces.

6. The apparatus according to claim 5, wherein the two first surfaces are adjacent to one another in the main body.

7. The apparatus according to claim 6, wherein the two first surfaces are disposed between the two second surfaces.

8. The apparatus according to claim 1, further comprising projections extending from the main body into a main opening in the main body, the projections extending along a length of the main body to guide the fiber optic connectors.

9. The apparatus according to claim 3, wherein the at least one first surface and the at least one second surface are disposed on a ceiling of the main body.

10. The apparatus according to claim 2, wherein the opening associated with the at least one first surface and the opening associated with the at least one second surface have a different configuration.

11. An apparatus for removing a plurality of fiber optic connectors comprising:
a main body to engage to at least a portion of each of the plurality of fiber optic connectors;
an extension extending rearwardly from the main body, the extension configured to be grasped by a user to remove the plurality of fiber optic connectors; and
means for engaging a portion of each of the plurality of fiber optic connectors wherein at least two of the fiber optic connectors are not unattached from a structure simultaneously.

12. The apparatus according to claim 11, wherein the means includes a rearward facing surface in the main body.

13. The apparatus according to claim 12, wherein the rearward facing surface forms at least a portion of an opening in a top surface of the main body.

14. The apparatus according to claim 12, wherein the rearward facing surface is disposed with a main opening in the main body.

15. The apparatus according to claim 11, wherein the means includes a main body having slots therein, at least two of the slots having a different length.

16. An apparatus for removing a plurality of fiber optic connectors comprising:
a plurality of fingers extending upward from a base at front end thereof, each of the fingers having at least one surface facing toward a Rear end of the base to engage a portion of a fiber optic connector; and
an opening between each of the plurality of fingers to receive the portion of the fiber optic connector, wherein at least two of the surfaces are parallel to one another but offset from each other.

17. The apparatus according to claim 16, wherein at least one of the plurality of fingers has two surfaces, the two surfaces have being parallel to one another but offset from each other.

18. The apparatus according to claim 16, further comprising an opening at the Rear end of the base, the opening configured to receive a portion of only one of the plurality of fiber optic connectors.
